(19) United States
(12) Patent Application Publication
(10) Pub. No.: US 2020/0039649 A1
(43) Pub. Date: Feb. 6, 2020

(54) REDUCED DRAG WINGSUIT

(71) Applicant: SQUIRREL, LLC, Seattle, WA (US)

(72) Inventor: Mathew GERDES, Seattle, WA (US)

(21) Appl. No.: 16/279,224

(22) Filed: Feb. 19, 2019

Related U.S. Application Data
(60) Provisional application No. 62/713,421, filed on Aug. 1, 2018.
(60) Provisional application No. 62/752,236, filed on Oct. 29, 2018.

(51) Int. Cl. B64D 10/00; A41D 13/00

(52) U.S. Cl. CPC B64D 10/00; A41D 2400/24; A41D 13/0015

(57) ABSTRACT

A method of constructing a reduced drag wing, including: providing a top wing surface panel; coupling a top surface external leading-edge panel to the external surface of the top wing surface panel, wherein the top surface external leading-edge panel extends forward from the top wing surface panel and extends rearward covering at least partially the top surface external leading-edge panel; coupling internal rib elements to the interior surface of the top wing surface panel; coupling the top surface external leading-edge panel to a sleeve element; coupling the rear sleeve element to a bottom wing surface panel; coupling the internal rib elements to the interior surface of the bottom wing surface panel; and coupling the top surface external leading-edge panel and the sleeve element to a releasable mechanical mechanism. A reduced drag wing for a wingsuit. A wingsuit including a reduced drag wing.

### CROSS-REFERENCE TO RELATED APPLICATION

This application claims the benefit of priority to U.S. Provisional Application Nos. 62/713,421, filed Aug. 1, 2018, and 62/752,236, filed Oct. 29, 2018, both of which are incorporated herein by reference in their entirety.

### TECHNICAL FIELD

This disclosure relates to a wingsuit for gliding flight, and more particularly, to a wingsuit having a reduced drag leading edge.

### BACKGROUND

Wingsuit flying is the sport of flying through the air using a wingsuit. The wingsuit is used to increase the surface area of the human body, which results in an increase in lift. Wingsuits typically increase their surface by including fabric between the legs and under the arms. Over time, wingsuits have evolved into a shaped airfoil with control surfaces typically actuated by a wearer's arms and/or legs.

Wingsuit flight can be thought of as controlled freefall where the control surfaces of the suit allow a wearer to navigate, with full control over roll, yaw, and pitch. Wingsuit flights are typically terminated with a parachute deployment. One of the goals of wingsuit design is to increase the ratio of lift to drag. The present application meets that goal.

### SUMMARY

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later. Additional aspects and advantages of this invention will be apparent from the following detailed description of preferred embodiments, which proceeds with reference to the accompanying drawings.

In one aspect, the present disclosure provides a method of constructing a reduced drag wing for a wingsuit, in which the method includes: providing a top wing surface panel having an external surface and an opposing internal surface, the top wing surface panel having a forward facing end and a rearward facing end; coupling a top surface external leading-edge panel to the external surface of the top wing surface panel, wherein the top surface external leading-edge panel extends forward from the forward facing end of the top wing surface panel and extends rearward from the forward facing end of the top wing surface panel covering at least partially the top surface external leading-edge panel; coupling internal rib elements to the interior surface of the top wing surface panel; coupling the top surface external leading-edge panel to a sleeve element; coupling the rear sleeve element to a bottom wing surface panel, the bottom wing surface panel having an external surface and an opposing internal surface; coupling the internal rib elements to the interior surface of the bottom wing surface panel; and coupling the top surface external leading-edge panel and the sleeve element to a releasable mechanical mechanism, thereby constructing a reduced drag wing for a wingsuit.

In some embodiments, the method further includes coupling the internal rib elements to the top surface external leading-edge panel.

In some embodiments, the method further includes coupling the internal rib elements to the sleeve element.

In some embodiments, the releasable mechanical mechanism comprises a zipper.

In some embodiments, the top surface external leading-edge panel comprises a zero porosity fabric.

In some embodiments, the zero porosity fabric comprises a woven and/or laminated zero porosity fabric.

In some embodiments, the zero porosity fabric is coated with a silicone or water-based coating on one or both sides.

In some embodiments, the zero porosity fabric comprises a 200 Denier or 210 Denier weight fabric.

In some embodiments, the zero porosity fabric comprises a vinyl-type fabric.

In some embodiments, the reduced drag wing has a wing chord and the leading edge top surface external leading-edge panel covers between 5% and 100% of the wing chord.

In some embodiments, the top surface external leading-edge panel covers about 5% to about 100% of the wing surface panel.

In some embodiments, the top wing surface panel, the internal rib elements; the top surface external leading-edge panel; the sleeve element and the bottom wing surface panel are configured to form a three-dimensional wing when inflated.

In some embodiments, the three-dimensional wing comprises an integral profile gripper that extends to an inflated edge of the wing, has a thickness proportional to a tapered reduction of the ribs from a wing root to a wingtip and is configured to create a fairing behind a wearer's hand.

In some embodiments, the integral profile gripper curves outward distally.

In some embodiments, the method further includes coupling the reduced drag wing to a remainder of a wingsuit.

In another aspect, the present disclosure provides a reduced drag wing for a wingsuit, in which the reduced drag wing includes: a top wing surface panel having an external surface, an opposing internal surface, a forward facing end, and a rearward facing end; a top surface external leading-edge panel coupled to the external surface of the top wing surface panel, wherein the top surface external leading-edge panel extends forward from forward facing end of the top wing surface panel and extends rearward from the forward facing end of the top wing surface panel covering at least partially the top surface external leading-edge panel; a bottom wing surface panel, the bottom wing surface panel having an external surface, an opposing internal surface, a forward facing end, and a rearward facing end; a sleeve element coupled to the forward facing end of the bottom wing surface panel and the forward facing end of the top wing surface panel; a plurality of internal rib elements coupled to the interior surface of the top wing surface panel and the interior surface of the bottom wing surface panel; and a releasable mechanical mechanism coupling the top surface external leading-edge panel and the sleeve element.

In some embodiments, the releasable mechanical mechanism comprises a zipper.

In some embodiments, the top surface external leading-edge panel comprises a zero porosity fabric.

In some embodiments, the zero porosity fabric comprises a woven and/or laminated zero porosity fabric.

In some embodiments, the zero porosity fabric is coated with a silicone or water-based coating on one or both sides.

In some embodiments, the zero porosity fabric comprises a 200 Denier or 210 Denier weight fabric.

In some embodiments, the zero porosity fabric comprises a vinyl-type fabric.

In some embodiments, the reduced drag wing has a wing chord and the leading edge top surface external leading-edge panel covers between about 5% and about 100% of the wing chord.

In some embodiments, the top surface external leading-edge panel covers about 5% to about 100% of the wing surface panel.

In some embodiments, the top wing surface panel; the internal rib elements; the top surface external leading-edge panel; the sleeve element and the bottom wing surface panel are configured to form a three-dimensional wing when inflated.

In some embodiments, the reduced drag wing further includes an integral profile gripper that extends to an inflated edge of the wing, has a thickness proportional to a tapered reduction of the ribs from a wing root to a wingtip, and is configured to create a fairing behind a wearer's hand.

In some embodiments, the integral profile gripper curves outward distally.

In another aspect, the present disclosure provides a wingsuit that includes a reduced drag wing.

### BRIEF DESCRIPTION OF THE DRAWINGS

FIG. 1A is a digital image showing the configuration of a test wing used to test the effect of a seam on the coefficients of lift and drag.

FIG. 1B is a graph showing the coefficient of lift (C_{L}) as a function of angle of attack (AOA). The baseline curve (Baseline 80) represents a smooth wing surface. The 210 parapack 80 curve represents a 210 denier parapack covered wing with monofilm leading edge to 20% chord on top and bottom. The 210 PP MLES 80 curve represents a 210 denier parapack covered wing with monofilm leading edge to 20% chord on top and bottom and a seam on the upper surface at 20% chord. The added top surface seam at 20% chord to the 210 PP covered wing results in a deep abrupt stall with some loss of CLmax.

FIG. 1C is a graph showing the coefficient of Drag (C_{D}) as a function of angle of attack (AOA). The baseline curve (Baseline 80) represents a smooth wing surface. The 210 parapack 80 curve represents a 210 denier parapack covered wing with monofilm leading edge to 20% chord on top and bottom. The 210 PP MLES 80 curve represents a 210 denier parapack covered wing with monofilm leading edge to 20% chord. The addition of the seam on the upper surface at 20% chord has a greater effect at low AOA and reaches baseline at lower AOA.

FIG. 1D is a graph showing the ratio of C_{L}/C_{D} as a function of angle of attack (AOA). The baseline curve (Baseline 80) represents a smooth wing surface. The 210 parapack 80 curve represents a 210 denier parapack covered wing with monofilm leading edge to 20% chord on top and bottom. The 210 PP MLES 80 curve represents a 210 denier parapack covered wing with monofilm leading edge to 20% chord on top and bottom and a seam on the upper surface at 20% chord. The addition of a top surface seam to the 210 PP covered wing at 20% chord has a large effect at low AOA.

FIGS. 2A-5 show the placement of the low drag panel on the leading edge.

FIGS. 6A-10 show the location of the extended wing profile onto the wingtip gripper. The placement of the wingtip gripper increases lift as a result of the additional wingtip surface area behind the pilot's hand.

FIG. 11 shows a wingsuit in flight that incorporates that elements of the wings as disclosed herein.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of the invention is defined by the appended claims.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

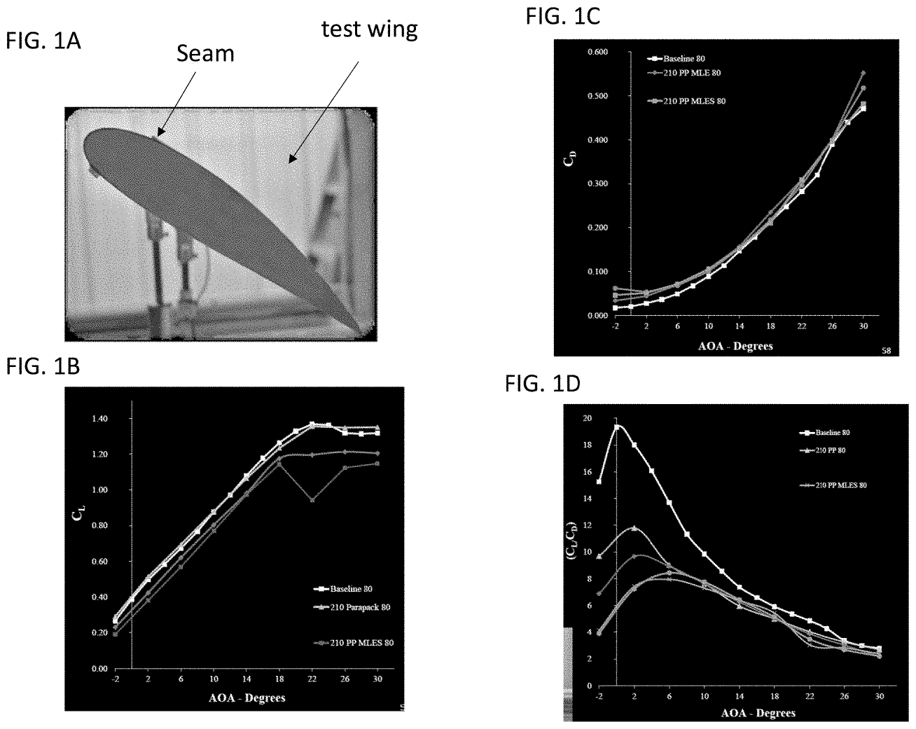

Drag reduction is a critical factor in wingsuit performance. As shown in FIGS. 1A-1D, one of the main drag sources on a wingsuit or the two laterally spaced wings, is a seam typically located on the leading edge of each of the wings of the wing suit. Prior to this disclosure, the portion of the wing that encircled outstretched arms of a wearer and connected the top surface of the wing to the bottom surface of the wing, was constructed of a separate element or piece of material that ran over the tops of the arms to connect to the top wing surface by a bulky seam to the bottom wing. This piece of material was connected to the top by a bulky seam, typically of doubled over fabric, and at the bottom by a zipper (which facilitates ingress and egress from the wingsuit). As demonstrated in FIGS. 1B-1D, the presence of a seam in this location has a detrimental effect on both the coefficient of drag (C_{D}) and the coefficient of lift (C_{L}) as well as the ratio of the two (C_{L}/C_{D}). As shown in FIGS. 1B-1D, a comparison of the baseline (smooth wing or covered wing) to a wing having a seam demonstrates that elimination of this seam will have a beneficial effect on the performance of a wingsuit. To take advantage of the gain in performance from the elimination of this seam, the inventor has developed a method of manufacturing a wingsuit that eliminates this seam (i.e. a seamless leading edge), and thus, an important source of drag. The resulting wingsuit design reduces drag in this critical area (namely the leading edge) by at least 7%, increasing lift and overall performance as a result. Prior to this disclosure, all existing wingsuit designs included a folded seam at this location (double thickness). The disclosed seamless leading edge design eliminates the seam and panel junction, reducing drag and increasing lift and allowing the use of a contiguous (single) low drag panel covering the entire leading edge from leading edge bottom surface to top surface extending up to 100% of the arm wing chord length. The reduction in drag that is inherent in the elimination of the seam results in an increase in lift and overall suit performance (Speed, glide, sink rate). The seamless leading edge is a design allowing the use of a single low-drag material panel covering the leading edge and a significant portion of the top surface of the arm wing's chord length. The seamless leading edge design eliminates the traditional spanwise seam, which joins the forward leading edge (arm) panel to the main wing surface panel. This new design creates a smoother and more contiguous airfoil surface, reducing turbulence and airflow detachment at the most critical part of the airfoil, the leading edge top surface. The Seamless Leading Edge design utilizes zero porosity, coated fabric.

### DETAILED DESCRIPTION OF SEVERAL EMBODIMENTS

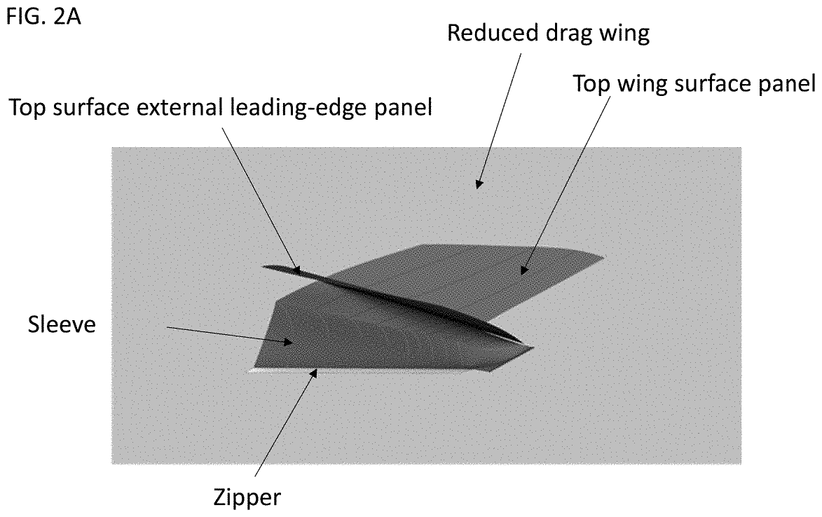

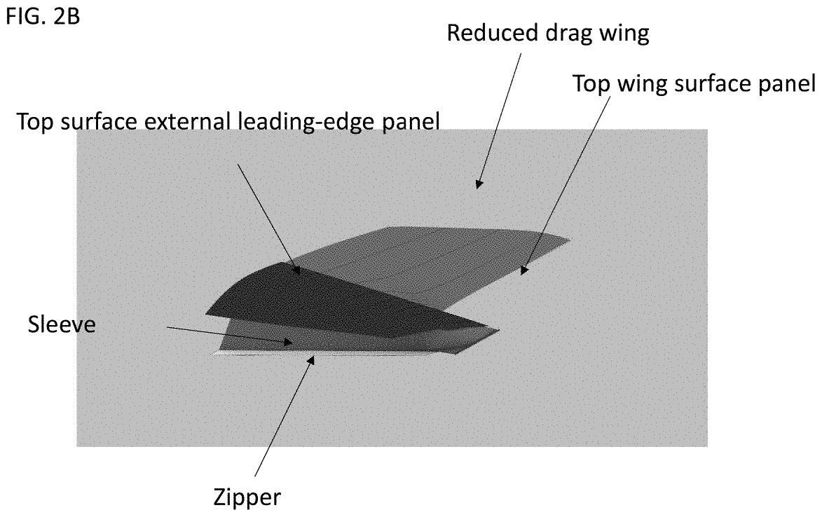

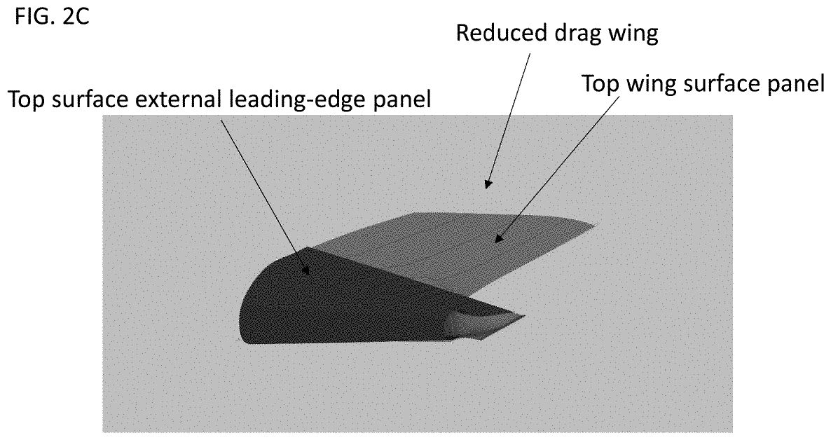

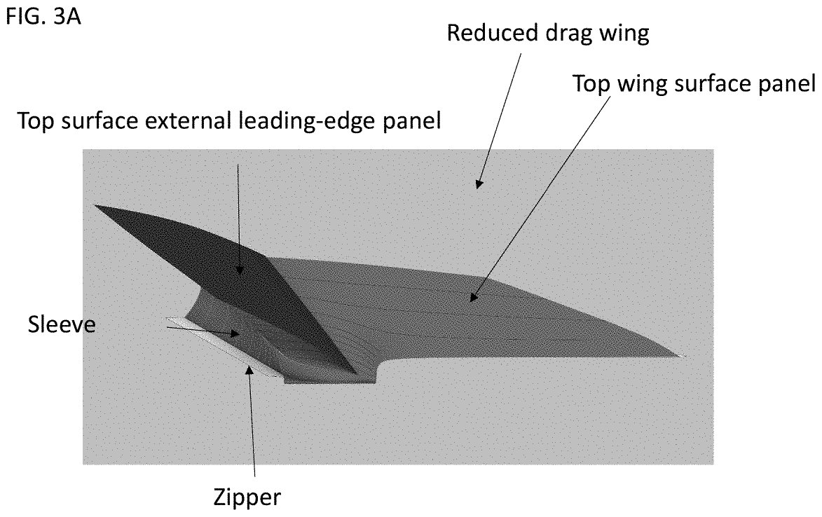

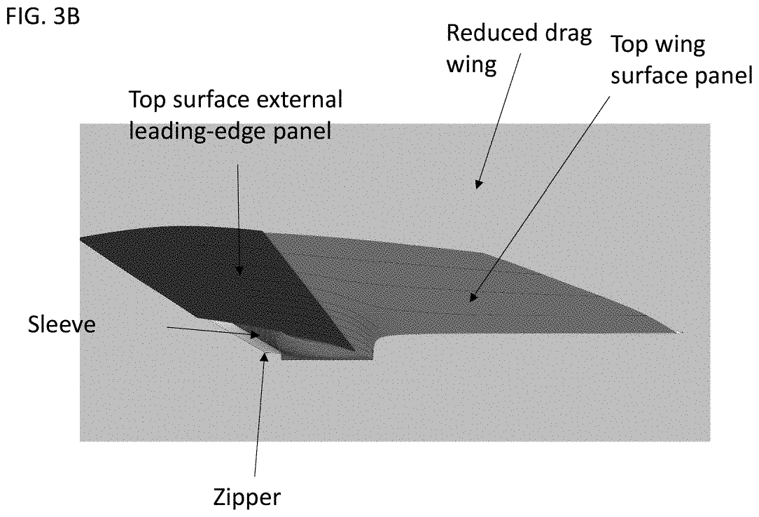

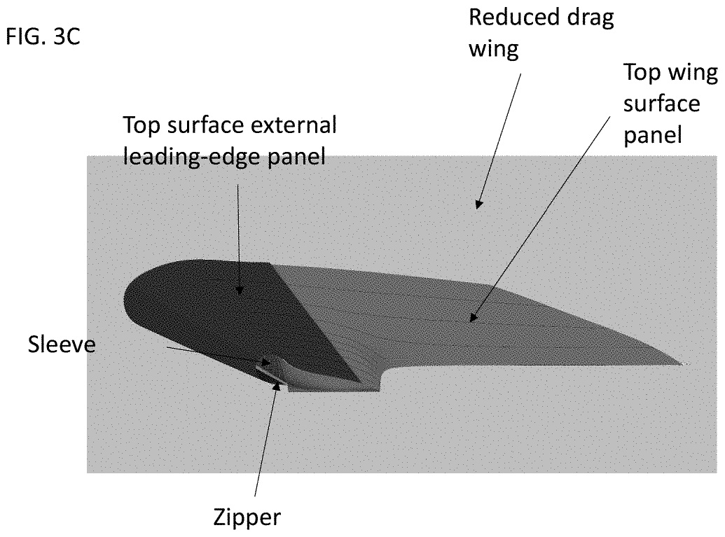

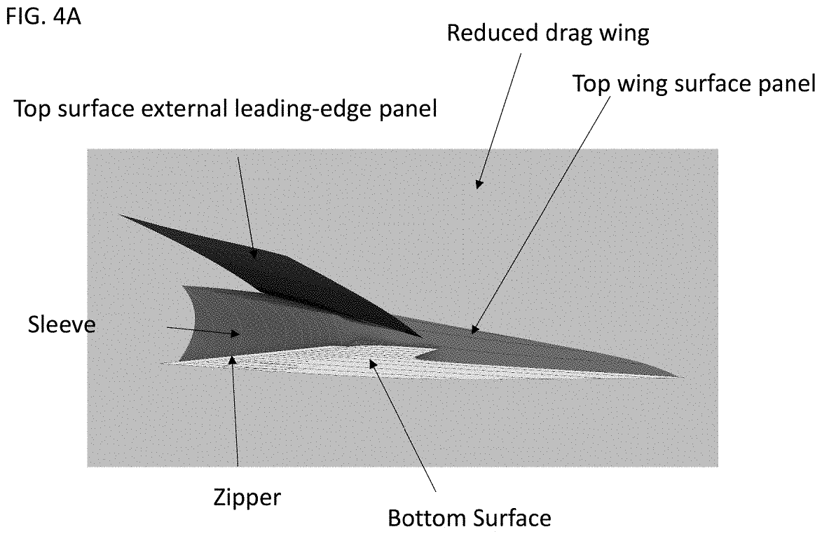

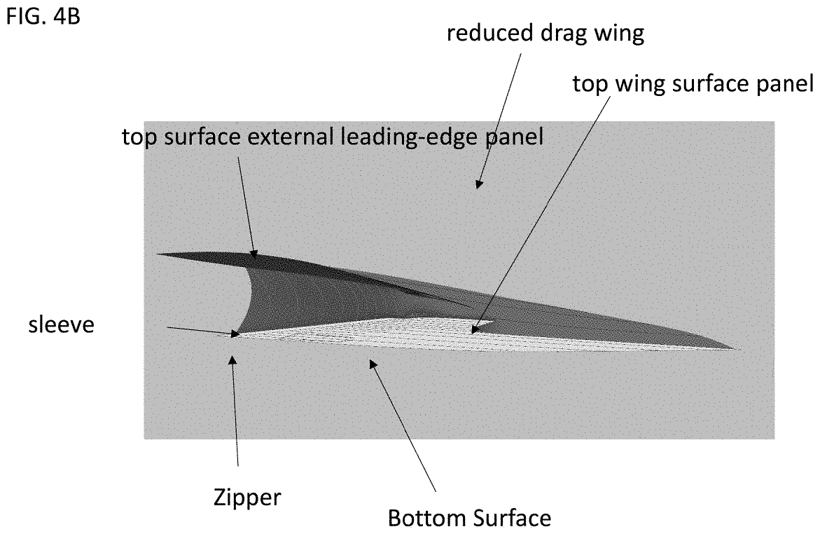

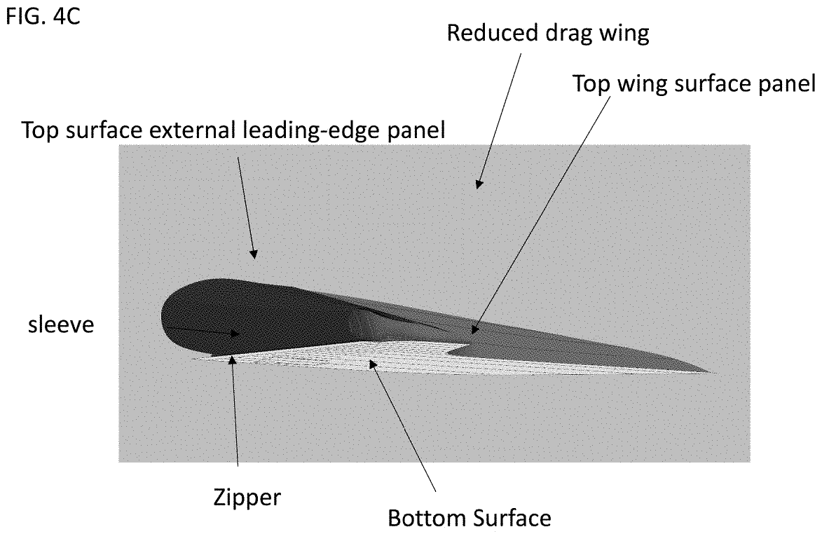

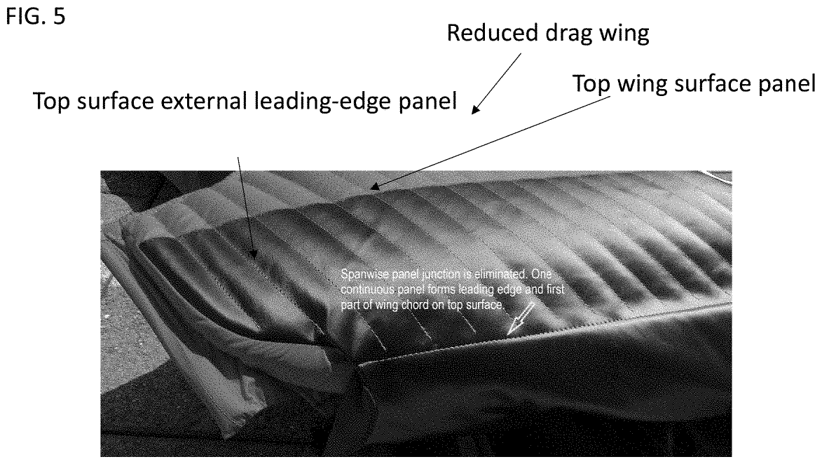

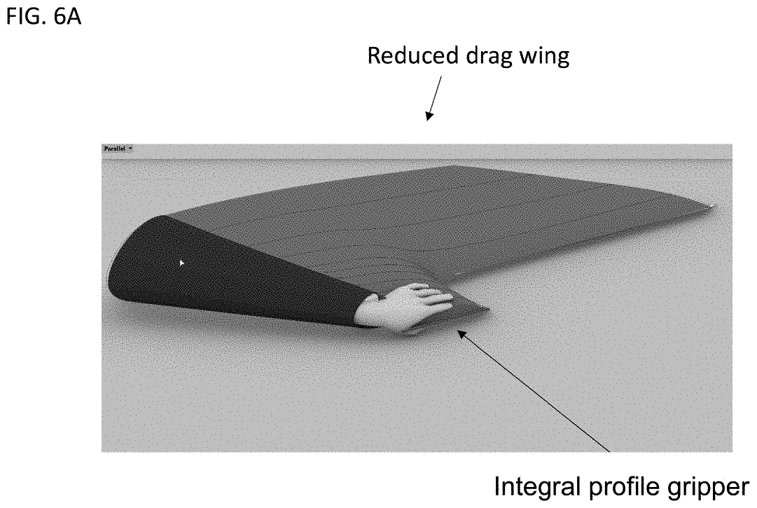

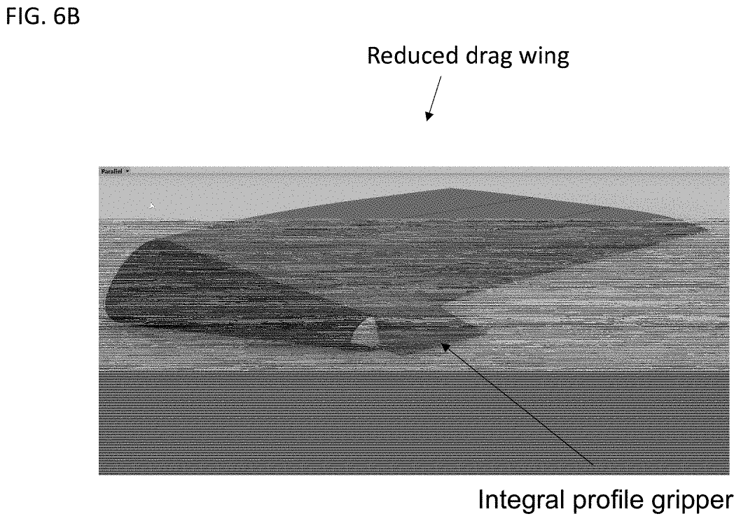

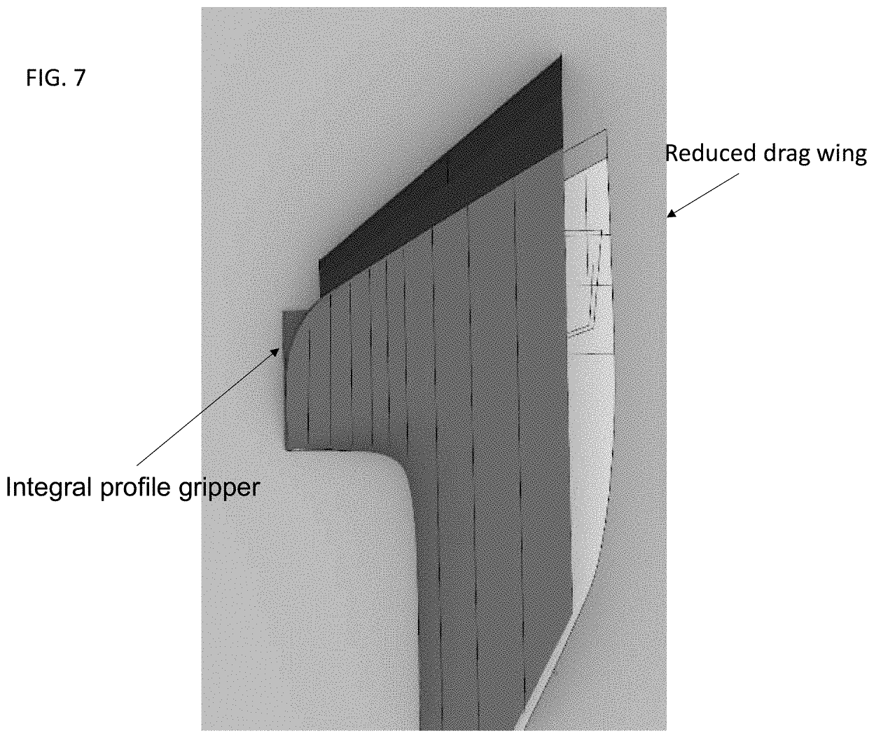

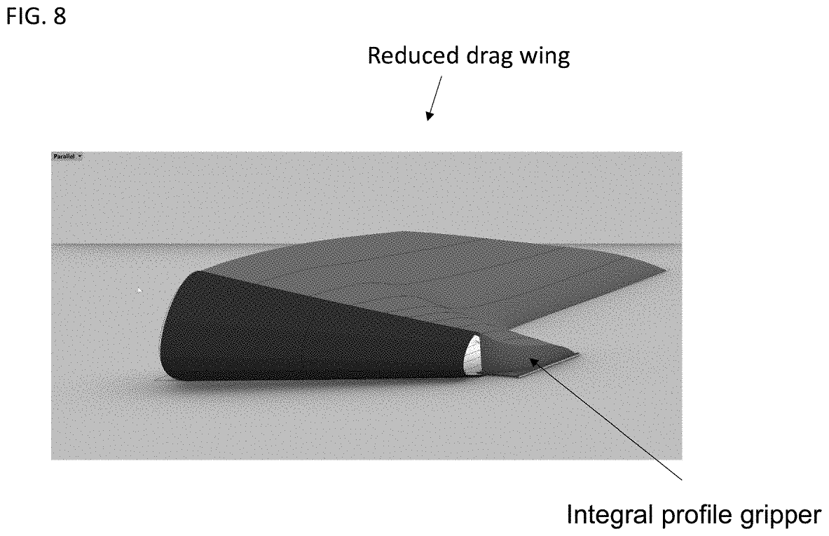

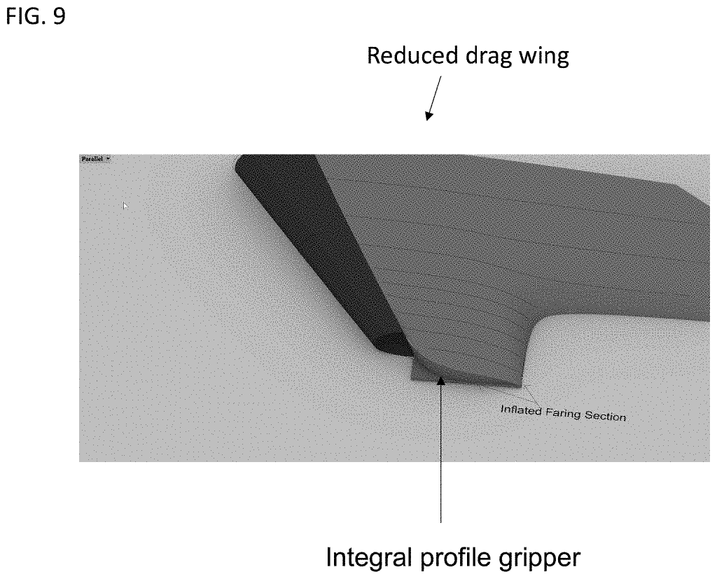

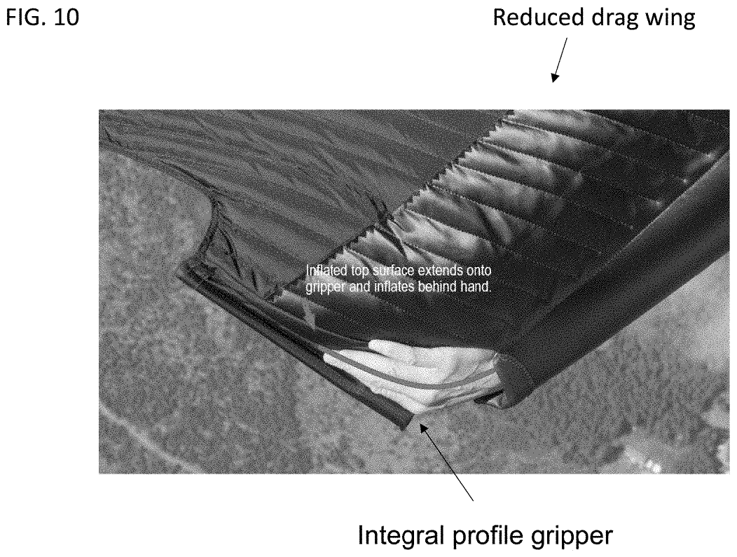

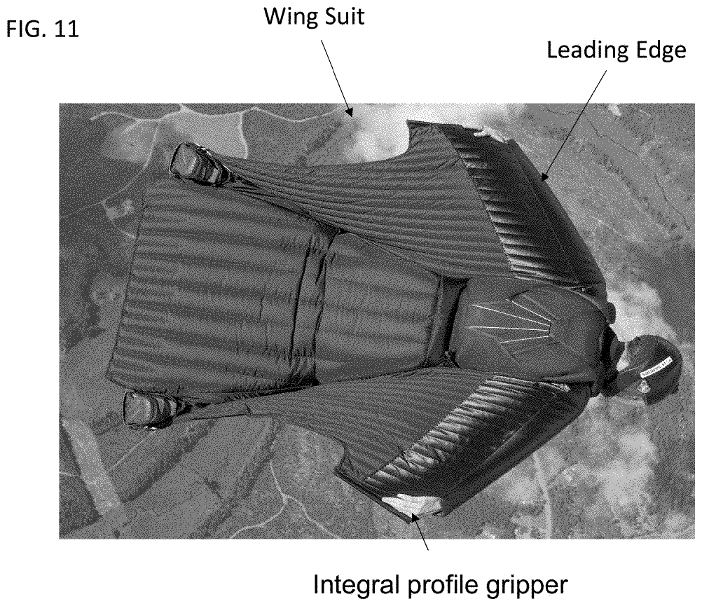

Aspects of the present disclosure concern a method of constructing or manufacturing a reduced drag wing for a wingsuit. An exemplary, non-limiting, methodology is shown in FIGS. 2A-4C. In embodiments, a top wing surface panel is provided, for example, as a starting material or platform to which to attach the other components of the low drag wing, as discussed below. The top wing surface panel includes an external surface and an opposing internal surface, the internal surface facing toward the center of the wing and the external surface facing away, the top wing surface panel further includes a forward facing end and a rearward facing end. As shown in FIGS. 2A, 3A, and 4A, a top surface external leading-edge panel is coupled to the external surface of the top wing surface panel, for example, bonded and/or sewn. For example, the top surface external leading-edge panel is sewn and/or bonded at the edges of the panel and optional bonded throughout the contact surface of the top surface external leading-edge panel and the top wing surface panel or a portion thereof. The top surface external leading-edge panel is configured to extend forward from forward facing end of the top wing surface panel rearward from the forward facing end of the top wing surface panel covering at least partially the top surface external leading-edge panel, see, for example, FIGS. 2B, 3B, and 4B. In embodiments, the forward facing end of the top wing surface panel and the external leading-edge panel are coupled together, for example, sewn and/or bonded together. FIG. 5 shows an embodiment in which the forward facing end of the top wing surface panel and the external leading-edge panel are sewn together. In embodiments, internal rib elements are coupled, such as sewn and/or bonded, to the interior surface of the top wing surface panel. The internal rib elements are typically chosen such that the resulting wing tapers from it thickest portion at the wing root closest to the body of a wearer to the wing tip. In certain embodiments, the internal rib elements are simultaneously coupled to the top surface external leading-edge panel while the internal rib elements are coupled to the interior surface of the top wing surface panel. In embodiments, the top surface external leading-edge panel and/or top wing surface panel is coupled to a sleeve element, see FIGS. 2B, 3B, and 4B. This sleeve element forms the bottom (when the wearer is standing) or rearward (when in flight, see FIG. 11) portion of the sleeve. The sleeve element is further coupled to a bottom wing surface panel to complete the wing. The wing can be completed by attaching the lateral and rear sides of the top wing surface panel and the bottom wing surface panel together to enclose a volume. In certain embodiments, the method includes coupling the internal rib elements to the sleeve element. In embodiments, the internal rib elements are coupled to the interior surface of the bottom wing surface panel. In certain embodiments, the top wing surface panel, the internal rib elements, the top surface external leading-edge panel, the sleeve element, and the bottom wing surface panel are configured to form a three-dimensional wing when inflated for example by air taken in from the exterior of the wing. In embodiments, the top surface external leading-edge panel and the sleeve element are individually coupled to a releasable mechanical mechanism, such as a zipper, that allows for the arm sections, for example as defined by the top surface external leading-edge panel and the sleeve element to be zipped on or off of a wearer.

In certain embodiments, the reduced drag wing has a wing chord and the leading edge top surface external leading-edge panel covers between about 5% and about 100% of the wing chord, for example about 5%, 6%, 7%, 8%, 9%, 10%, 11%, 12,%, 13%, 14%, 15%, 16%, 17%, 18%, 19%, 20%, 21%, 22%, 23%, 24%, 25%, 26%, 27%, 28%, 29%, 30%, 31%, 32,%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72,%, 73%, 74%, 75%, 76%, 77%, 78%, 79%, 80%, 81%, 82,%, 83%, 84%, 85%, 86%, 87%, 88%, 89%, 90%, 91%, 92%, 93%, 94%, 95%, 96%, 97%, 98%, 99%, or about 100%, such as between about 5% and about 30%, about 20% and about 50%, about 30% and about 75% or even about 50% and about 100%. In certain embodiments, the top surface external leading-edge panel covers about 5% to about 100% of the wing surface panel, for example, about 5%, 6%, 7%, 8%, 9%, 10%, 11%, 12,%, 13%, 14%, 15%, 16%, 17%, 18%, 19%, 20%, 21%, 22%, 23%, 24%, 25%, 26%, 27%, 28%, 29%, 30%, 31%, 32,%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72,%, 73%, 74%, 75%, 76%, 77%, 78%, 79%, 80%, 81%, 82,%, 83%, 84%, 85%, 86%, 87%, 88%, 89%, 90%, 91%, 92%, 93%, 94%, 95%, 96%, 97%, 98%, 99%, or about 100%, such as between about 5% and about 30%, about 20% and about 50%, about 30% and about 75% or even about 50% and about 100%.

In certain embodiments, the various surfaces and panels may be made of poly/cotton blends, nylon, spandex, cordura, and parapak. In certain embodiments, the top surface external leading-edge panel comprises a zero porosity fabric. In certain embodiments, the zero porosity fabric comprises a woven and/or laminated zero porosity fabric. In certain embodiments, the zero porosity fabric is coated with a silicone or water-based coating on one or both sides. In certain embodiments, the zero porosity fabric comprises an approximately 200 Denier weight fabric. In certain embodiments, the zero porosity fabric comprises an approximately 210 Denier weight fabric. In certain embodiments, the zero porosity fabric comprises a vinyl-type fabric.

All existing wingsuit designs with “grippers” do not include an extended profile segment in the distal span behind the pilot's hand on the gripper. To provide additional lift, the inventor has developed an integral profile gripper. This design provides additional lifting surface behind the pilot's hand by extending the arm wing profile onto the gripper surface at the wingtip, for example covering up to 100% of the wingtip chord length. Compared to an identical suit without the integral profile gripper, one that includes an integral profile gripper has a lower stall speed and higher glide ratio, increasing performance and safety simultaneously with no reduction in ease of use. The integral profile gripper extends the profile of the wingsuit arm wing onto the rigid gripper structure located at the wingtip. It is both a drag-reducing fairing for the pilot's hand, and an addition of effective wing surface, but without actually increasing arm wing surface area in the platform.

In certain embodiments, the integral profile gripper is assembled in a manner that integrates the rigid gripper into the inflated edge of the wing, and creates a fairing behind the pilot's hand that is a thickness proportional to the tapered reduction of the ribs from wing root to wingtip. The top surface of the arm wing is extended nearly to the edge of the rigid gripper structure, curving outward distally to form a drag-reducing fairing for the pilot's hand.

In embodiments, the integral profile gripper is constructed from zero-porosity (non-porous) fabrics. In embodiments, the fairing is inflated or is semi-rigid (open or closed cell foam) and extends to the edge of the rigid gripper stick. In certain embodiments, the inflated three-dimensional wing comprises an integral profile gripper that extend to an inflated edge of the wing and is configured to create a fairing behind a wearer's hand that is a thickness proportional to a tapered reduction of the ribs from wing root to wingtip. In certain embodiments, the integral profile gripper curves outward distally.

In certain embodiments, the method includes coupling the reduced drag wing to the remainder of a wingsuit.

Aspects of the present disclosure concern a reduced drag wing for a wingsuit, for example, as made by the methods disclosed herein. In embodiments, the reduced drag wing does not include a seam, such as a sewn seam, between a leading-edge panel and top wing surface panel, for example, at the front end of the top wing surface panel. In embodiments, the reduced drag wing includes: a top wing surface panel having an external surface, an opposing internal surface, a forward facing end, and a rearward facing end, and a top surface external leading-edge panel coupled to the external surface of the top wing surface panel, wherein the top surface external leading-edge panel extends forward from forward facing end of the top wing surface panel and extends rearward from the forward facing end of the top wing surface panel covering at least partially the top surface external leading-edge panel. The reduced drag wing further includes a bottom wing surface panel, the bottom wing surface panel having an external surface, an opposing internal surface a forward facing end, and a rearward facing end, and a sleeve element coupled to the forward facing end of the bottom wing surface panel and the forward facing end of the top wing surface panel. A plurality of internal rib elements are coupled to the interior surface of the top wing surface panel and the interior surface of the bottom wing surface panel, for example, to provide a profile for forming the three-dimensional airfoil structure of the low drag wing. A releasable mechanical mechanism may be used to couple the top surface external leading-edge panel and the sleeve element. In certain embodiments, the releasable mechanical mechanism comprises a zipper.

In certain embodiments, the top surface external leading-edge panel comprises a zero porosity fabric. In certain embodiments, the zero porosity fabric comprises a woven and/or laminated zero porosity fabric. In certain embodiments, the zero porosity fabric is coated with a silicone or water-based coating on one or both sides. In certain embodiments, the zero porosity fabric comprises an approximately 200 Denier weight fabric. In certain embodiments, the zero porosity fabric comprises a vinyl-type fabric.

In certain embodiments, the reduced drag wing has a wing chord and the leading edge top surface external leading-edge panel covers between about 5% and about 100% of the a wing chord, for example, about 5%, 6%, 7%, 8%, 9%, 10%, 11%, 12,%, 13%, 14%, 15%, 16%, 17%, 18%, 19%, 20%, 21%, 22%, 23%, 24%, 25%, 26%, 27%, 28%, 29%, 30%, 31%, 32,%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72,%, 73%, 74%, 75%, 76%, 77%, 78%, 79%, 80%, 81%, 82,%, 83%, 84%, 85%, 86%, 87%, 88%, 89%, 90%, 91%, 92%, 93%, 94%, 95%, 96%, 97%, 98%, 99%, or about 100%, such as between about 5% and about 30%, about 20% and about 50%, about 30% and about 75% or even about 50% and about 100%. In certain embodiments, the top surface external leading-edge panel covers about 5% to about 100% of the wing surface panel, for example, about 5%, 6%, 7%, 8%, 9%, 10%, 11%, 12,%, 13%, 14%, 15%, 16%, 17%, 18%, 19%, 20%, 21%, 22%, 23%, 24%, 25%, 26%, 27%, 28%, 29%, 30%, 31%, 32,%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72,%, 73%, 74%, 75%, 76%, 77%, 78%, 79%, 80%, 81%, 82,%, 83%, 84%, 85%, 86%, 87%, 88%, 89%, 90%, 91%, 92%, 93%, 94%, 95%, 96%, 97%, 98%, 99%, or about 100%, such as between about 5% and about 30%, about 20% and about 50%, about 30% and about 75% or even about 50% and about 100%.

In certain embodiments, the integral profile gripper is assembled in a manner that integrates the rigid gripper into the inflated edge of the wing, and creates a fairing behind the pilot's hand that is a thickness proportional to the tapered reduction of the ribs from wing root to wingtip. The top surface of the arm wing is extended nearly to the edge of the rigid gripper structure, curving outward distally to form a drag-reducing fairing for the pilot's hand.

In embodiments, the integral profile gripper is constructed from zero-porosity (non-porous) fabrics. In embodiments, the fairing is inflated or is semi-rigid (open or closed cell foam) and extends to the edge of the rigid gripper stick. In certain embodiments, the inflated three-dimensional wing comprises a an integral profile gripper that extend to an inflated edge of the wing and is configured to create a fairing behind a wearer's hand that is a thickness proportional to a tapered reduction of the ribs from wing root to wingtip. In certain embodiments, the integral profile gripper curves outward distally.

Aspects of the present disclosure further relate to a wingsuit that includes a reduced drag wing as described above, an example of which is shown in FIG. 11. Typically, the wingsuit includes interconnected torso, groin, arm sleeves and leg cover portions, the arm sleeves being integral to a disclosed reduced drag wing. There are neck, leg and arm openings. On each side of the torso section, there are the lift assist and control surfaces, comprised of disclosed reduced drag wings, and a tail. These control surfaces may be tailored to the skill of the user.

In embodiments, the reduced drag wings are a ram-air inflatable structure. Ram air scoops may be used to inflate the lift assist structures (reduced drag wing and tail). The intake from these air scoops inflates and flows through a series of chambers sewn into the fabric before exiting through openings. The internal walls separating chambers, for example ribs, may have one or more valves or slits connecting one chamber to another. In this fashion, the air flows in parallel from a chamber closest to the air scoop to another, until it reaches one or more exit openings. To assist this structure's integrity, the fabric used in one embodiment may be comprised of single, double or more cloth layers. In an alternate embodiment, the suit fabric is made of a composite sandwich having a denser fabric between the outer and inner skin.

Although certain embodiments, have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

1. A method of constructing a reduced drag wing for a wingsuit, comprising:
providing a top wing surface panel having an external surface and an opposing internal surface, the top wing surface panel having a forward facing end and a rearward facing end;
coupling a top surface external leading-edge panel to the external surface of the top wing surface panel, wherein the top surface external leading-edge panel extends forward from the forward facing end of the top wing surface panel and extends rearward from the forward facing end of the top wing surface panel covering at least partially the top surface external leading-edge panel;
coupling internal rib elements to the interior surface of the top wing surface panel;
coupling the top surface external leading-edge panel to a sleeve element;
coupling the rear sleeve element to a bottom wing surface panel, the bottom wing surface panel having an external surface and an opposing internal surface;
coupling the internal rib elements to the interior surface of the bottom wing surface panel; and
coupling the top surface external leading-edge panel and the sleeve element to a releasable mechanical mechanism, thereby constructing a reduced drag wing for a wingsuit.

2. The method of claim 1, further comprising coupling the internal rib elements to the top surface external leading-edge panel.

3. The method of claim 1, further comprising coupling the internal rib elements to the sleeve element.

4. The method of claim 1, wherein in the releasable mechanical mechanism comprises a zipper.

5. The method of claim 1, wherein the top surface external leading-edge panel comprises a zero porosity fabric.

6. The method of claim 5, wherein the zero porosity fabric is (a) a woven zero porosity fabric; (b) a laminated zero porosity fabric; (c) a zero porosity fabric coated with a silicone or water-based coating on one or both sides; (d) a zero porosity fabric that is a 200 Denier weight fabric; or (e) a zero porosity fabric that is a vinyl-type fabric.

7. (canceled)

8. (canceled)

9. (canceled)

10. The method of claim 1, wherein the reduced drag wing has a wing chord and the leading edge top surface external leading-edge panel covers between about 5% and about 100% of the a wing chord.

11. The method of claim 1, wherein the top surface external leading-edge panel covers about 5% to about 100% of the wing surface panel.

12. The method of claim 1, wherein in combination the top wing surface panel, the internal rib elements: the top surface external leading-edge panel; the sleeve element and the bottom wing surface panel are configured to form a three-dimensional wing when inflated.

13. The method of claim 12, wherein the three-dimensional wing comprises an integral profile gripper that extends to an inflated edge of the wing, has a thickness proportional to a tapered reduction of the ribs from a wing root to a wingtip and is configured to create a fairing behind a wearer's hand.

14. The method of claim 13, wherein the integral profile gripper curves outward distally.

15. The method of claim 1, further comprising, coupling the reduced drag wing to a remainder of a wingsuit.

16. A reduced drag wing for a wingsuit, comprising:
a top wing surface panel having an external surface, an opposing internal surface a forward facing end, and a rearward facing end;
a top surface external leading-edge panel coupled to the external surface of the top wing surface panel, wherein the top surface external leading-edge panel extends forward from forward facing end of the top wing surface panel and extends rearward from the forward facing end of the top wing surface panel covering at least partially the top surface external leading-edge panel;
a bottom wing surface panel, the bottom wing surface panel having an external surface, an opposing internal surface, a forward facing end, and a rearward facing end;
a sleeve element coupled to the forward facing end of the bottom wing surface panel and the forward facing end of the top wing surface panel;
a plurality of internal rib elements coupled to the interior surface of the top wing surface panel and the interior surface of the bottom wing surface panel; and
a releasable mechanical mechanism coupling the top surface external leading-edge panel and the sleeve element.

17. The reduced drag wing of claim 16, wherein the releasable mechanical mechanism comprises a zipper.

18. The reduced drag wing of claim 16, wherein the top surface external leading-edge panel comprises a zero porosity fabric.

19. The reduced drag wing of claim 18, wherein the zero porosity fabric is (a) a woven zero porosity fabric; (b) a laminated zero porosity fabric; (c) a zero porosity fabric coated with a silicone or water-based coating on one or both sides; (d) a zero porosity fabric that is a 200 Denier weight fabric; or (e) a zero porosity fabric that is a vinyl-type fabric.

20. (canceled)

21. (canceled)

22. (canceled)

23. The reduced drag wing of claim 16, wherein the reduced drag wing has a wing chord and the leading edge top surface external leading-edge panel covers between about 5% and about 100% of the a wing chord.

24. The reduced drag wing of claim 16, wherein the top surface external leading-edge panel covers about 5% to about 100% of the wing surface panel.

25. The reduced drag wing of claim 16, wherein in combination: the top wing surface panel; the internal rib elements; the top surface external leading-edge panel; the sleeve element and the bottom wing surface panel are configured to form a three-dimensional wing when inflated.

26. The reduced drag wing of claim 25, further comprising an integral profile gripper that extends to an inflated edge of the wing, has a thickness proportional to a tapered reduction of the ribs from a wing root to a wingtip, and is configured to create a fairing behind a wearer's hand.

27. The reduced drag wing of claim 26, wherein the integral profile gripper curves outward distally.

28. A wingsuit comprising the reduced drag wing of claim 16.

29. An integral profile gripper for a wingsuit, comprising:
a rigid gripper stick; and
an extension to an inflated edge of a wing of a wingsuit, wherein the integral profile gripper has a thickness proportional to a tapered reduction of ribs from a wing root to a wingtip and is configured to create a fairing behind a wearer's hand.

30. The integral profile gripper of claim 29, wherein the integral profile gripper curves outward distally.

31. The integral profile gripper of claim 29, wherein the integral profile gripper includes an extended profile segment in the distal span behind the wearer's hand on the gripper.

32. The integral profile gripper of claim 29, wherein the integral profile gripper provides additional lifting surface behind the pilot's hand by extending the arm wing profile onto the gripper surface at the wingtip.

33. The integral profile gripper of claim 29, wherein the integral profile gripper covers between about 60% and 100% of the wingtip chord length.

34. The integral profile gripper of claim 29, wherein the rigid gripper stick is located at the wingtip and/or integrated into the inflated edge of the wingsuit wing.

35. (canceled)

36. The integral profile gripper of claim 29, wherein a top surface of the arm wing is extended nearly to the edge of integral profile gripper curving outward distally to form a drag-reducing fairing for the wearer's hand.

37. The integral profile gripper of claim 29, wherein the integral profile gripper is constructed from zero-porosity (non-porous) fabrics.

38. The integral profile gripper of claim 29, wherein the integral profile gripper fairing is inflated or is semi-rigid (open or closed cell foam).

39. A three-dimensional wing, comprising the integral profile gripper of claim 29.

40. A wingsuit, comprising the integral profile gripper of claim 29.
